(19) United States
(12) Patent Application Publication
(10) Pub. No.: US 2017/0348618 A1
(43) Pub. Date: Dec. 7, 2017

(54) FILTER MEDIUM, PROCESS FOR PRODUCING FILTER MEDIUM, FILTRATION DEVICE, METHOD FOR OPERATING FILTRATION DEVICE, AND FILTRATION SYSTEM

(71) Applicant: MITSUBISHI HEAVY INDUSTRIES, LTD., Tokyo (JP)

(72) Inventor: Kiyoshi Tatsuhara, Tokyo (JP)

(73) Assignee: MITSUBISHI HEAVY INDUSTRIES, LTD., Tokyo (JP)

(21) Appl. No.: 15/540,737

(22) PCT Filed: Jan. 6, 2015
(86) PCT No.: PCT/JP2015/050127

§ 371 Date: Jun. 29, 2017

(51) Int. Cl. B01D 24/46; B01D 37/03; B01D 61/02; B01D 61/04; B01J 20/20; C02F 1/44; C02F 1/28; C02F 1/00; B01J 20/30; C01B 32/336; B01J 20/28; C02F 1/52; C02F 103/08

(52) U.S. Cl. CPC B01D 24/4631; B01J 20/28092; B01D 37/03; B01D 61/025; B01D 61/04; B01J 20/20; B01J 20/28069; C02F 1/52; C02F 1/441; C02F 1/283; C02F 1/008; B01J 20/3085; C01B 32/336; B01J 20/28083; B01D 2101/04; B01D 2101/02; C01P 2006/14; C01P 2006/16; C02F 2103/08; C02F 2303/16

(57) ABSTRACT

To provide a filter medium, a process for producing filter medium, a filtration device, a method for operating the filtration device, and a filtration system, which are capable of promptly regenerating the adsorption power by backwashing and realizing efficient operation of a filtration device. The filter medium of the present invention contains a carbon-based material in which a cumulative pore volume of pores having a pore radius of 2 nm or less is 25% or less with respect to a cumulative pore volume of pores having a pore radius of 50 nm or less.

### FIELD

The present invention relates to a filter medium, a process for producing the filter medium, a filtration device, a method for operating the filtration device, and a filtration system, and more specifically, relates to a filter medium, a process for producing the filter medium, a filtration device, a method for operating the filtration device, and a filtration system, which are capable of efficiently removing suspended substances in water to be treated.

### BACKGROUND

Hitherto, fillers for water purifiers using fibrous activated carbon have been proposed (see, for example, Patent Literature 1). In this filler for water purifier, a fibrous activated carbon is used having a specific surface area of 1,300 m²/g or more as well as setting the cumulative pore volume occupied by pores having a pore radius of 0.9 nm or more and 1.6 nm or less to be in a predetermined range. Accordingly, the filler for water purifier is possible to efficiently remove trihalomethane present in tap water at an extremely low concentration of about several ppb.

### CITATION LIST

### Patent Literature

Patent Literature 1: JP 3122205 B1

### SUMMARY

### Technical Problem

Incidentally, in a desalination apparatus to desalinate seawater by a reverse osmosis membrane filtration device, a filtration device (pretreatment device) such as a dual media filter (DMF) that filters seawater to be supplied to the reverse osmosis membrane filtration device to decrease the concentration of suspended substances is used in order to prevent contamination of the reverse osmosis membrane. In such a filtration device, filtration of seawater causes clogging of filter medium such as activated carbon and the pressure loss increases, and it is thus required to periodically conduct backwashing after operation for a predetermined period to remove dirt from the filter medium.

However, general activated carbon to be used as a filter medium in a conventional filtration device has a specific surface area of 1000 m²/g or more and also a great number of fine pores having a diameter of about several nm. Thus there is no significant difference between the pore size of activated carbon and the molecular size of suspended substances such as organic substances contained in seawater. For this reason, it is difficult to promptly remove the suspended substances adsorbed to the activated carbon in the conventional filter medium even if backwashing is conducted, and the filtration device cannot be necessarily efficiently operated in some cases.

The present invention has been achieved in view of such circumstances, and an object thereof is to provide a filter medium, a process for producing the filter medium, a filtration device, a method for operating the filtration device, and a filtration system, which are capable of promptly regenerating the adsorption power by backwashing and realizing efficient operation of the filtration device.

### Solution to Problem

In a filter medium of this invention, a cumulative pore volume of pores having a pore radius of 2 nm or less is 25% or less with respect to a cumulative pore volume of pores having a pore radios of 50 nm or less.

According to this configuration, the micropores having a pore radius of 0.8 nm or more and 2 nm or less and the submicropores having a pore radius of 0.8 nm or less, which make it difficult to desorb the adsorbed suspended substances from the filter medium at the time of backwashing, are decreased. It is thus possible to promptly desorb the suspended substances from the filter medium at the time of backwashing. This makes it possible to realize a filter medium capable of more promptly regenerating the adsorption power by backwashing and realizing more efficient operation of a filtration device.

The filter medium of this invention is preferable to comprises a carbon-based material By this configuration, the filter medium has a lower specific gravity than the filter sand that is generally used in the sand filter layer of the filtration device and it is thus easy to provide a filter layer on the sand filter layer. In addition, the affinity of the filter medium for organic substances is improved, and it is thus possible to efficiently remove the suspended substances due to the organic substances in the water to be treated.

In the filter medium of this invention, the carbon-based material is preferable to contain activated carbon. By this configuration, the filter medium has a lower specific gravity than the filter sand that is generally used in the sand filter layer of the filtration device and it is thus easier to provide a filter layer on the sand filter layer. In addition, the affinity of the filter medium for organic substances is improved, and it is thus possible to efficiently remove the suspended substances due to the organic substances in the water to be treated.

A process for producing filter medium of this invention is a process for producing the filter medium and a carbon-based material is activated by water vapor.

A process for producing filter medium of this invention is a process for producing the filter medium and a carbon-based material is activated by a carbonic acid gas.

According to these processes, micropores having a pore radius of 0.8 nm or more and 2 nm or less in the carbon-based material are appropriately destroyed by an activation treatment with water vapor or a carbonic acid gas. It is thus possible to set the cumulative pore volume of pores having a pore radius of 2 nm or less to be 25% or less with respect to the cumulative pore volume of pores having a pore radius of 50 nm or less. This makes it possible for the method of manufacturing a filter medium to realize a filter medium capable of promptly desorbing the suspended substances from the filter medium at the time of backwashing as well as efficiently adsorbing the suspended substances in the water to be treated.

In the process for producing filter medium of this invention, it is preferable that the activation treatment is conducted with water vapor under a condition having a surface temperature of the carbon-based material of 750° C. or higher. By this method, the method of manufacturing a filter medium can appropriately destroy micropores having a pore radius of 2 nm or less in the carbon-based material, and it is thus easy to set the cumulative pore volume of pores having a pore radius of 2 nm or less to be 25% or less with respect to the cumulative pore volume of pores having a pore radius of 50 nm or less of the filter medium.

In the process for producing filter medium of this invention, it is preferable that the activation treatment is conducted with the carbonic acid gas under a condition having a surface temperature of the carbon-based material of 850° C. or higher. By this method, the method of manufacturing a filter medium can appropriately destroy micropores having a pore radius of 2 nm or less in the carbon-based material, and it is thus easy to set the cumulative pore volume of pores having a pore radius of 2 nm or less to be 25% or less with respect to the cumulative pore volume of pores having a pore radius of 50 nm or less of the filter medium.

In the process for producing filter medium of this invention, it is preferable that the activation treatment is conducted until a mass decrease of the carbon-based material reaches 50% or more. By this method, the destruction of micropores having a pore radius of 2 nm or less in the carbon-based material is conducted in an appropriate range, and it is thus easy to set the cumulative pore volume of pores having a pore radius of 2 nm or less to be 25% or less with respect to the cumulative pore volume of pores having a pore radius of 50 nm or less of the filter medium.

A filtration device of this invention comprises the filter medium or the filter medium obtained by the process for producing the filter medium.

According to this filtration device, a filter medium in which the cumulative pore volume of pores having a pore radius of 2 nm or less is 25% or less with respect to the cumulative pore volume of pores having a pore radius of 50 nm or less is equipped, and it is thus possible to efficiently desorb the suspended substances retained in the filter medium from the filter medium at the time of backwashing as well as to efficiently remove the suspended substances contained in the water to be treated. Hence, the filtration device can realize a filtration device capable of promptly regenerating the adsorption power by backwashing and realizing efficient operation.

A method for operating filtration device of this invention is a method for operating the filtration device, and the method comprises: a filtering step of filtering water to be treated through the filter medium to decrease suspended substances in the water to be treated; and a washing step of washing the filter medium by backwashing when an amount of suspended substances in water to be treated filtered through the filter medium reaches one third of a total amount adsorbed to the filter medium.

According to this method for operating the filtration device, it is possible to conduct backwashing under a condition having a sufficient margin with respect to the adsorption capacity of the filter medium and thus to prevent the adsorption of the suspended substances in the water to be treated to micropores having a pore radius of 2 nm or less from which it is difficult to desorb the suspended substances in the filter medium. This makes it possible to promptly desorb the suspended substances adsorbed to the filter medium from the filter medium at the time of backwashing, and it is thus possible to realize a method of operating a filtration device capable of promptly regenerating the adsorption power by backwashing and realizing efficient operation.

A method for operating filtration device of this invention is a method for operating the filtration device, and the method comprises: a concentration of suspended substances measuring step of measuring a first concentration of suspended substances in the water to be treated and measuring a second concentration of suspended substances in filtered water, the filtered water is obtained by filtering the water to be treated through the filter medium; and a filter medium washing step of conducting a calculation of a difference value between a first time integrated value of the first concentration of suspended substances measured and a second time integrated value of the second concentration of suspended substances measured and conducting a backwashing of the filter medium when the difference value calculated is equal to or less than a predetermined value.

According to this method for operating the filtration device, the filter medium is backwashed when the performance of the filter medium is deteriorated and the second concentration of suspended substances in the filtered water with respect to the first concentration of suspended substances in the water to be treated is equal to or higher than a predetermined value, and it is thus possible to appropriately wash the filter medium according to a change in the second concentration of suspended substances in the filtered water. This makes it possible to promptly desorb the suspended substances adsorbed to the filter medium from the filter medium at the time of backwashing, and it is thus possible to realize a method of operating a filtration device capable of promptly regenerating the adsorption power by backwashing and realizing efficient operation.

A filtration system of this invention comprises: a water to be treated filtering unit equipped with the filtration device according to claim 9 that filters water to be treated supplied through a water to be treated line to obtain filtered water; and a salt enriching unit that filters the filtered water through a separation membrane to obtain permeated water and enriched water.

According to this filtration system, a filtration device in which the micropores having a pore radius of 0.8 nm or more and 2 nm or less and the submicropores having a pore radius of 0.8 nm or less, which make it difficult to desorb the adsorbed suspended substances from the filter medium at the time of backwashing are decreased is equipped and it is thus possible to promptly desorb the suspended substances from the filter medium at the time of backwashing. This makes it possible to more promptly regenerate the adsorption power of the filter medium of the filtration device by backwashing and to realize more efficient operation of the filtration system.

### Advantageous Effects of Invention

According to the present invention, it is possible to realize a filter medium, a process for producing filter medium, a filtration device, a method for operating the filtration device, and a filtration system, which are capable of promptly regenerating the adsorption power by backwashing and realizing efficient operation of the filtration device.

### BRIEF DESCRIPTION OF DRAWINGS

FIG. 1 is an outline diagram of a water treatment apparatus according to an embodiment of the present invention.

FIG. 2 is a schematic cross-sectional diagram illustrating an example of a dual media filtration device according to an embodiment of the present invention.

FIG. 3 is a schematic diagram of a general filter medium using activated carbon.

FIG. 4 is a schematic diagram of a filter medium according to an embodiment of the present invention.

FIG. 5A is a diagram illustrating the relationship between the filtration time through a general filter medium using activated carbon and the concentration of suspended substances in filtered water.

FIG. 5B is a diagram illustrating the relationship between the filtration time through a filter medium according to an embodiment of the present invention and the concentration of suspended substances in filtered water.

FIG. 6 is a diagram illustrating the relationship between the cumulative pore volume and the pore radius of a filter medium according to an embodiment of the present invention.

FIG. 7 is a schematic cross-sectional diagram illustrating another example of a dual media filtration device according to an embodiment of the present invention.

FIG. 8 is a flow diagram of a method of operating a filtration device according to an embodiment of the present invention.

FIG. 9 is a schematic diagram of a filtration system according to an embodiment of the present invention.

### DESCRIPTION OF EMBODIMENTS

Hereinafter, embodiments of the present invention will be described in detail with reference to the accompanying drawings. Incidentally, the present invention is not limited to the following embodiments and can be implemented with appropriate modifications. In addition, the respective following embodiments can be implemented in appropriate combination.

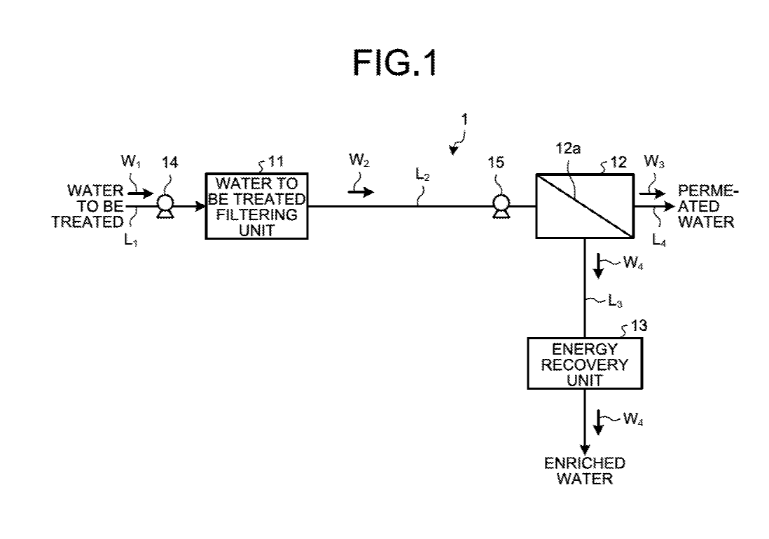

First, the outline of a water treatment apparatus equipped with a filtration device according to an embodiment of the present invention will be briefly described. FIG. 1 is an outline diagram of a water treatment apparatus according to an embodiment of the present invention. As illustrated in FIG. 1, a water treatment apparatus 1 according to the present embodiment is a water treatment apparatus in which filtered water W₂ obtained by filtering water to be treated W₁ through a water to be treated filtering unit 11 as a dual media filtration device. In the water treatment apparatus 1, the filtered water W₂ obtained is filtrated through a reverse osmosis membrane 12a of a reverse osmosis membrane filtering unit 12 to obtain permeated water W₃ and enriched water W₄. The water to be treated W₁ is not particularly limited, and for example, it is possible to use seawater, river water, lake water, groundwater, municipal sewage, brackish water, industrial water, industrial wastewater, and water obtained by subjecting these water to treatments such as aggregation, precipitation, filtration, adsorption, and a biological treatment.

The water treatment apparatus 1 according to the present embodiment is equipped with: the water to be treated filtering unit 11 to which the water to be treated W₁ is supplied through a water to be treated line L₁; the reverse osmosis membrane filtering unit 12 provided to a filtered water line L₂ of the subsequent stage of the water to be treated filtering unit 11; and an energy recovery unit 13 provided to an enriched water line L₃ of the subsequent stage of the reverse osmosis membrane filtering unit 12.

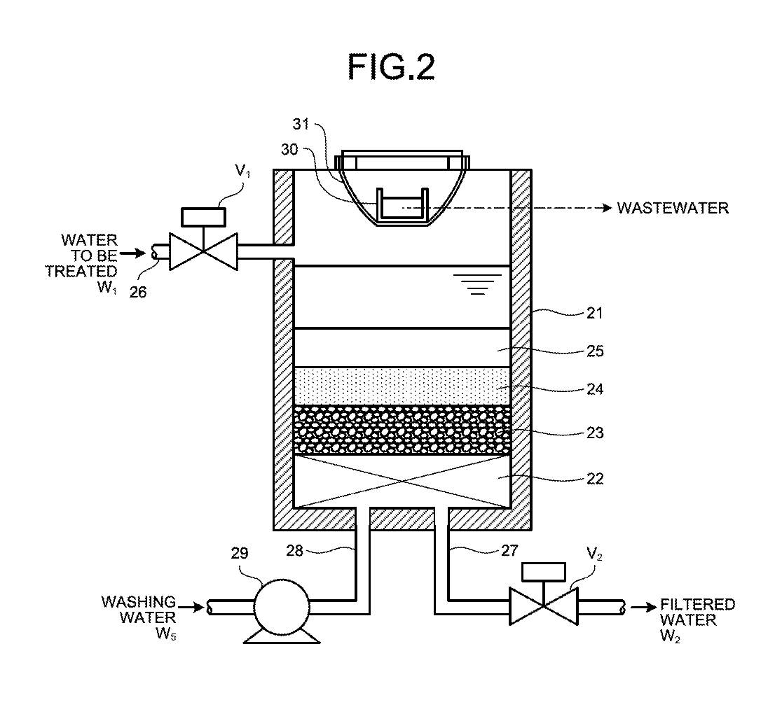

The water to be treated W₁ is supplied through the water to be treated line L₁ to the water to be treated filtering unit 11 by a liquid sending pump 14. The water to be treated filtering unit 11 filters the water to be treated W₁ to obtain the filtered water W₂ from which the suspended substances in the water to be treated W₁ is removed. As the water to be treated filtering unit 11, for example, it is possible to use a dual media filter (DMF) in which a first filter layer 24 (not illustrated in FIG. 1, see FIG. 2) and a second filter layer 25 (not illustrated in FIG. 1, see FIG. 2) are layered. The first filter layer 24 contains a filter medium according to the present embodiment, and the second filter layer 25 contains silica sand having a relatively smaller particle size with respective to the filter medium according to the present embodiment.

In the water to be treated filtering unit 11, the pH of the filtered water W₂ is adjusted with an acid such as H₂SO₄ or HCl so as to have a predetermined value (for example, pH 7.2 or lower) if necessary. By adjusting the pH as described above, it is possible to decrease the malfunction such as contamination (fouling) of the reverse osmosis membrane 12a of the reverse osmosis membrane filtering unit 12 due to the suspended substances in the water to be treated W₁.

The pressurized filtered water W₂ is supplied to the reverse osmosis membrane filtering unit 12 through the filtered water line L₂ by a high pressure pump 15. The reverse osmosis membrane filtering unit 12 is equipped with the reverse osmosis membrane 12a which permeates the filtered water W₂ supplied from the water to be treated filtering unit 11 to obtain the permeated water W₃ and the enriched water W₄ in which salts and the like in the filtered water W₂ are enriched. The reverse osmosis membrane filtering unit 12 discharges the permeated water W₃ through a permeated water line L₄ as well as discharges the enriched water W₄ through the enriched water line L₃.

A filter member such as a micro cartridge filter may be further provided between the water to be treated filtering unit 11 and the reverse osmosis membrane filtering unit 12. By allowing the filtered water W₂ to pass through the filter member, it is possible to remove fine particles which affect contamination of the reverse osmosis membrane 12a of the reverse osmosis membrane filtering unit 12.

The energy recovery unit 13 recovers the energy of the high-pressure enriched water W₄ pressurized by the high pressure pump 15. The energy recovered by the energy recovery unit 13 is used, for example, as the energy for driving the high pressure pump 15 and the energy for transducing the pressure of the filtered water W₂ to a high pressure. This makes it possible for the water treatment apparatus 1 to improve the energy efficiency of the entire water treatment apparatus 1.

As the energy recovery unit 13, for example, it is possible to use a Pelton Wheel type energy recovery device, a Turbocharger type energy recovery device, a PX (Pressure Exchanger) type energy recovery device, and a DWEER (DualWorkEnergy Exchanger) type energy recovery device.

Next, the water to be treated filtering unit 11 according to the present embodiment will be described in detail with reference to FIG. 2. FIG. 2 is a schematic cross-sectional diagram of the water to be treated filtering unit 11 according to the present embodiment. As illustrated in FIG. 2, this water to be treated filtering unit 11 is a gravity filtration device. This water to be treated filtering unit 11 includes, for example, a rectangular parallelepiped-shaped filter tank 21. A perforated block 22 as a filter bed is provided at the lower portion of the filter tank 21. A ground layer 23 is provided on the perforated block 22 by gravel covered in layers. A first filter layer 24 is provided on the ground layer 23 by sand covered in layers. A second filter layer 25 is provided on the first filter layer 24 by a filter media covered in layers. The second filter layer 25 is configured to include the filter medium according to the present embodiment. This filter medium has a relatively lower specific gravity than the sand constituting the first filter layer 24, and the particle size of the filter medium is relatively larger than the sand.

At the upper portion of the filter tank 21, a water to be treated supply pipe 26 is provided above the second filter layer 25. Seawater as the water to be treated W₁ is supplied into the filter tank 21 through the water to be treated supply pipe 26. Incidentally, a flocculant such as ferric chloride is added to this seawater. This water to be treated supply pipe 26 is provided with a flow regulating valve V₁ which opens and closes the water to be treated supply pipe 26 to adjust the flow rate of the water to be treated W₁. At the lower portion of the filter tank 21, a filtered water effluence pipe 27 is provided below the perforated block 22. This filtered water effluence pipe 27 is provided with a flow regulating valve V₂ capable of adjusting the flow rate of the filtered water W₂ by opening and closing the filtered water effluence pipe 27. In addition, a washing water supply pipe 28 is provided below the perforated block 22 at the lower portion of the filter tank 21. This washing water supply pipe 28 is provided with a liquid sending pump 29 which sends washing water W₅ into the filter tank 21.

In addition, a drainage gutter 30 that is substantially U-shaped in cross-sectional view and extends in a substantially horizontal direction is provided above the second filter layer 25. This drainage gutter 30 is supported by the filter tank 21 via a beam member (not illustrated). Both ends having an aperture of the drainage gutter 30 are connected to a drainage port (not illustrated) formed on the wall of the filter tank 21. In addition, the position of the upper surface in the vertical direction of the drainage gutter 30 is positioned below the upper end of the filter tank 21. A filter medium effluence preventing net 31 which prevents effluence of the filter medium is provided around the drainage gutter 30. This filter medium effluence preventing net 31 is supported by the filter tank 21 by a support member (not illustrated).

In this water to be treated filtering unit 11, the water to be treated W₁ supplied into the filter tank 21 through the water to be treated supply pipe 26 sequentially passes through the second filter layer 25, the first filter layer 24, the ground layer 23, and the perforated block 22 as a downward flow, so that the suspended substances in the water to be treated W₁ are adsorbed and removed by the second filter layer 25 and the first filter layer 24 and the filtrated water W₂ is thus obtained. This filtered water W₂ is discharged out of the filter tank 21 through the filtered water effluence pipe 27.

Moreover, after the operation for a predetermined period, the washing water W₅ is supplied into the filter tank 21 through the washing water supply pipe 28 provided at the lower portion of the filter tank 21 by the liquid sending pump 29, and the first filter layer 24 and the second filter layer 25 are backwashed. This washing water W₅ sequentially passes through the perforated block 22, the ground layer 23, the first filter layer 24, and the second filter layer 25 as an upward flow. By this, the suspended substances adsorbed to the first filter layer 24 and the second filter layer 25 are desorbed from the first filter layer 24 and the second filter layer 25 and removed as wastewater by the washing water W₅, and the first filter layer 24 and the second filter layer 25 are thus regenerated. The wastewater containing the suspended substances is discharged via the drainage gutter 30 installed at the upper portion of the filter tank 21. Incidentally, the first filter layer 24 and the second filter layer 25 are backwashed as it is judged that the first filter layer 24 and the second filter layer 25 have reached the adsorption equilibrium of the suspended substances in a case in which the concentration of suspended substances in the filtered water W₂ reaches a predetermined concentration or higher (for example, 2 mg/kg as TOC (Total Organic Carbon)).

Next, the filter medium according to the present embodiment will be described in detail. The filter medium according to the present embodiment is one which constitutes the second filter layer 25 described above, and in which the cumulative pore volume of pores having a pore radius of 2 nm or less is 25% or less with respect to the cumulative pore volume of pores having a pore radius of 50 nm or less. Incidentally, in the present invention, the pore radius and the pore volume are values measured by the nitrogen adsorption method in conformity with JIS Z 8831-2: 2010 and JIS Z 8831-2: 2010.

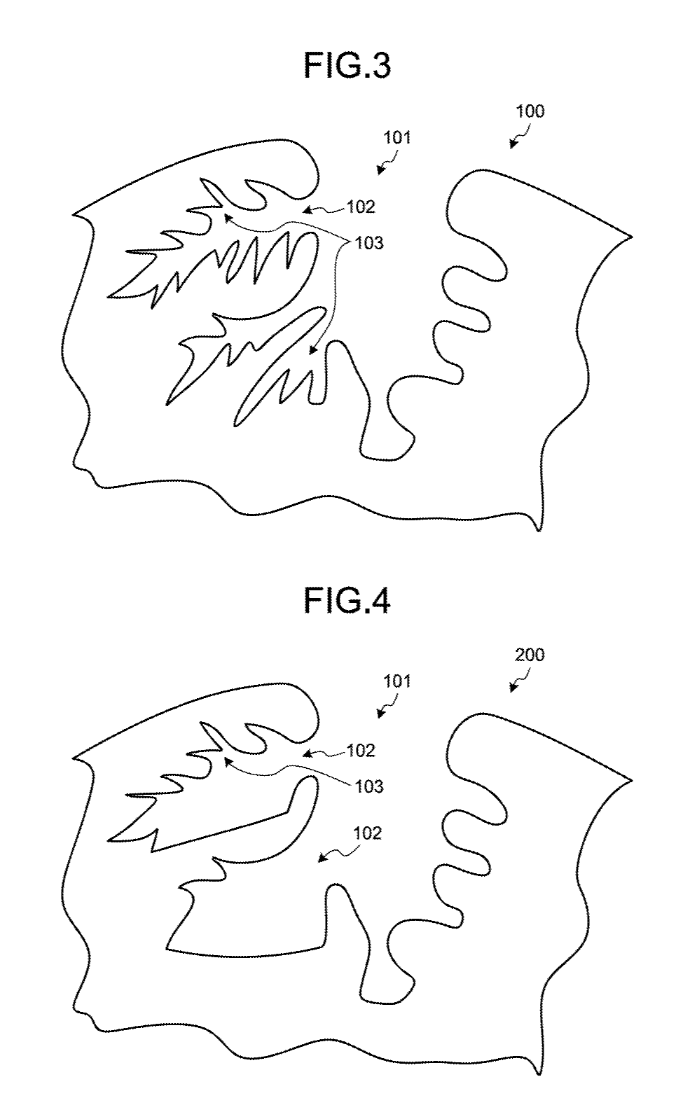

Here, the filter medium will be described in detail with reference to FIGS. 3 and 4. FIG. 3 is a schematic diagram of a general filter medium using activated carbon, and FIG. 4 is a schematic diagram of the filter medium according to the present embodiment. As illustrated in FIG. 3, a macropore 101 having a pore radius of 50 nm or more is formed on the surface of a general filter medium 100 using activated carbon. In this macropore 101, a plurality of mesopores 102 having a pore radius of 2 nm or more and 50 nm or less are formed. In the plurality of these mesopores 102, a large number of micropores 103 having a pore radius of 0.8 nm or more and 2 nm or less are formed. In the plurality of micropores 103, submicropores (not illustrated) having a pore radius of 0.8 nm or less are formed. In the filter medium 100, the micropores 103 accounts for 25% or more and 75% or less in the total pore volume, and the magnitude of the specific surface area becomes 1000 m²/g or more by this. Accordingly, the filter medium 100 has an excellent adsorption capacity to the suspended substances in the water to be treated W₁. However, the molecular radius of the macromolecule such as a polysaccharide which is the suspended substances in the water to be treated W₁ is equivalent to the inner diameter of the micropore 103. The suspended substances adsorbed to the inside of the micropore 103 maintain a state of being adsorbed to the filter medium 100 even if washing water passes through at the time of backwashing of the filtration device and are not easily desorbed from the filter medium 100 in some cases. Furthermore, the macromolecule adsorbed in the pores deteriorates the adsorptivity of the filter medium since it gradually elutes over a long period of time in some cases.

On the other hand, as illustrated in FIG. 4, in a filter medium 200 according to the present embodiment, a part of the micropores 103 of the filter medium 200 is destroyed by an activation treatment or the like. The cumulative pore volume of pores having a pore radius of 2 nm or less is thus 25% or less with respect to the cumulative pore volume of pores having a pore radius of 50 nm or less. This makes it possible to decrease the amount of suspended substances adsorbed to the deep inside of the micropore 103 while securing the adsorption capacity to the suspended substances by the plurality of mesopores 102 and the appropriate number of micropores 103. It is thus possible to promptly desorb the suspended substances at the time of backwashing in the filter medium 200.

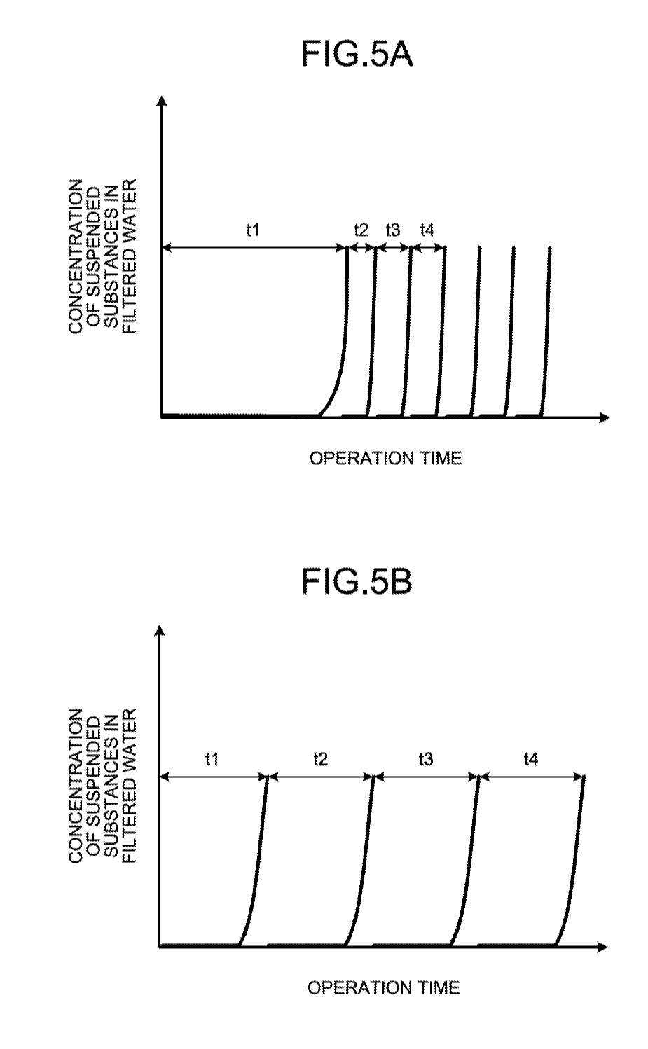

Next, the relationship between the operation time of the filtration device and the concentration of suspended substances in the filtered water W₂ will be described with reference to FIGS. 5A and 5B. FIG. 5A is a diagram illustrating the relationship between the filtration time through a general filter medium using activated carbon and the concentration of suspended substances in the filtered water W₂. FIG. 5B is a diagram illustrating the relationship between the filtration time through the filter medium according to the present embodiment and the concentration of suspended substances in the filtered water W₂.

As illustrated in FIG. 5A, in the general filter medium using activated carbon having a specific surface area of 1000 m²/g or more, the cumulative pore volume of pores having a pore radius of 2 nm or less exceeds 25% with respect to the cumulative pore volume of pores having a pore radius of 50 nm or less. For this reason, in the case of using a general filter medium, the operation time t1 until the first backwashing of the filter medium 100 after the start of operation is long, but the operation times t2 to t4 until the second backwashing to the fourth backwashing of the filter medium 100 are greatly shortened. It is considered that this result is because a relatively long operation time t1 can be secured until the first backwashing since the suspended substances are adsorbed to a large number of micropores 103 inside the filter medium 100 until the first backwashing after the start of operation. On the other hand, it is considered that this result is because the suspended substances once adsorbed to the micropore 103 are desorbed from the filter medium 100 only to a certain extent even by backwashing and a large number of micropores 103 are clogged by the suspended substances and the operation times t2 to t4 until the second backwashing to the fourth backwashing are thus shortened.

On the contrary, as illustrated in FIG. 5B, in the filter medium 200 according to the present embodiment, the operation time t1 until the first backwashing of the filter medium 200 after the start of operation is shorter as compared to the general filter medium 100 using activated carbon. On the other hand, the operation times t2 to t4 until the second backwashing to the fourth backwashing of the filter medium 200 are substantially constant, to be the same as the operation time t1, the total operation time t1 to t4 until the first backwashing to the fourth backwashing is longer as compared to the case of the filter medium 100. It is considered that this result is because the ratio of the micropores 103 from which it is difficult to desorb the adsorbed suspended substances is appropriately decreased and the cumulative pore volume of pores having a pore radius of 2 nm or less is 25% or less with respect to the cumulative pore volume of pores having a pore radius of 50 nm or less in the filter medium 200 according to the present embodiment. Thus the suspended substances adsorbed to the filter medium 200 are efficiently desorbed by backwashing and the filter medium 200 can be efficiently regenerated.

As described above, according to the filter medium 200 of the present embodiment, the cumulative pore volume of pores having a pore radius of 2 nm or less is 25% or less with respect to the cumulative pore volume of pores having a pore radius of 50 nm or less. Thus the pore radius of pores of the filter medium 200 is appropriately greater with respect to the molecular size of the suspended substances such as organic substances contained in the water to be treated W₁. It is possible to appropriately prevent the adsorption of suspended substances to the fine pores of the filter medium 200 and to efficiently desorb the suspended substances retained in the filter medium 200 from the filter medium 200 at the time of backwashing. This makes it possible to promptly desorb the suspended substances adsorbed to this filter medium 200 at the time of backwashing without impairing the adsorption efficiency to the suspended substances in the water to be treated W₁, and it is thus possible to regenerate the filter medium 200 in a short time and to efficiently operate the filtration device.

The specific surface area of the filter medium 200 according to the present embodiment is preferably 100 m²/g or more, since the adsorption capacity to the suspended substances contained in the water to be treated W₁ is improved. This increases the time until the filter medium 200 breaks through as compared to a case in which the specific surface area of the filter medium 200 is less than 100 m²/g, and thus it is possible to increase the operation time until the backwashing and the operation efficiency of the filtration device is improved. In addition, according to the filter medium 200, the specific surface area is preferably 150 m²/g or more and more preferably 200 m²/g or more from the viewpoint of even further improving the adsorption capacity to the suspended substances described above. The specific surface area is preferably 800 m²/g or less, more preferably 500 m²/g or less, and still more preferably 400 m²/g or less from the viewpoint of even more efficiently desorbing the suspended substances at the time of backwashing. In consideration of the facts described above, the specific surface area of the filter medium 200 is preferably 100 m²/g or more and 800 m²/g or less, more preferably 150 m²/g or more and 500 m²/g or less, and still more preferably 200 m²/g or more and 400 m²/g or less.

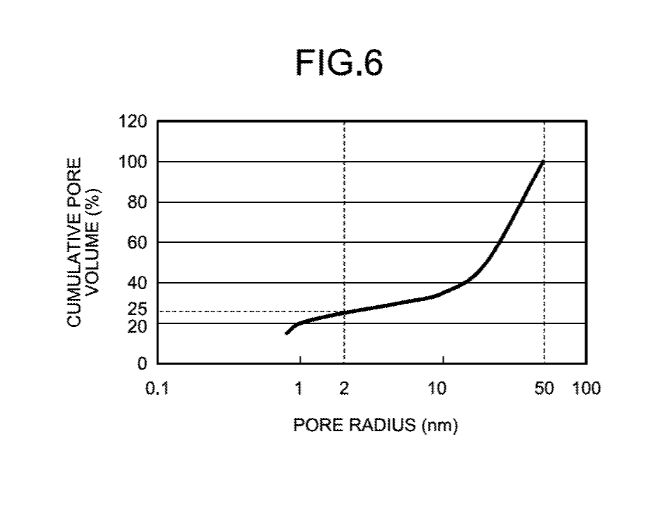

Next, the relationship between the cumulative pore volume and the pore radius of the filter medium 200 measured by the method of JIS Z 8831-3: 2010 will be described with reference to FIG. 6. Incidentally, the cumulative pore volume is the cumulative volume of the entire pores belonging to the filter medium 200 in a measurable range. FIG. 6 is a diagram illustrating the relationship between the cumulative pore volume and the pore radius of the filter medium 200 according to the present embodiment. Incidentally, in FIG. 6, the horizontal axis indicates the pore radius (nm) of the filter medium 200 and the vertical axis indicates the cumulative pore volume (%) of the filter medium 200. As illustrated in FIG. 6, in the present embodiment, the specific surface area is set to 100 m²/g or more and 800 m²/g or less by appropriately removing the micropores 103 having a pore radius of 2 nm or less by an activation treatment or the like. Thus the cumulative pore volume of pores having a pore radius of 2 nm or less is smaller than that of general activated carbon and can be set to be 25% or less with respect to the cumulative pore volume of pores having a pore radius of 50 nm or less. This decreases the micropores 103 having a pore radius of 0.8 nm or more and 2 nm or less and the submicropores having a pore radius of 0.8 nm or less from which it is difficult to desorb the adsorbed suspended substances from the filter medium at the time of backwashing, and it is thus possible to promptly desorb the suspended substances from the filter medium at the time of backwashing. As a result, it is possible to realize a filter medium capable of more promptly regenerating the adsorption power by backwashing and realizing more efficient operation of the filtration device.

In the filter medium according to the present embodiment, the cumulative pore volume of pores having a pore radius of 2 nm or less is preferably 25% or less, more preferably 10% or less, and still more preferably 1% or less with respect to the cumulative pore volume of pores having a pore radius of 50 nm or less from the viewpoint of even further improving the effect described above.

Here, the cumulative pore volume will be described. In general, the saturated vapor pressure in the pores of the filter medium decreases depending on the curvature of the surface of the filter medium by the function of the surface tension, and thus the adsorption capacity increases as the specific surface area increases and the number of curved surfaces increases. In addition, the saturated vapor pressure P₀^{r} in the pores having a pore radius r is represented by the Kelvin equation of the following Formula (1). In general, the adsorption capacity increases as p/p₀ increases, and thus the adsorption capacity increases as p₀ decreases.

$$ln ( {p}_{0}^{r} / {P}_{0} ) = - ( \frac{2 {V}_{m} γ}{RTr} ) cos θ \qquad Formula ( 1 )$$

(In Formula (1), p₀ represents the saturated vapor pressure of the liquid plane surface. Vₘ represents the surface molar volume of the liquid. γ represents the surface tension of the liquid. R represents the gas constant. T represents the absolute temperature. θ represents the contact angle between the liquid and the pore wall.)

The cumulative pore volume is determined from the pore radius distribution. The pore radius distribution can be determined by comparing the adsorption isotherms by the t-plot method or the αₛ-plot method which conforms to JIS Z 8831-3: 2010. In these methods, the nitrogen adsorption isotherm representing the relationship between the adsorption capacity and the pressure is measured and compared with the standard sample to determine the pore radius distribution. Moreover, the adsorption capacity increases by the presence of pores, and thus the pore radius distribution is determined by determining the volume of the pores from an increase in adsorption capacity corresponding to the pore radius.

As the filter medium 200, various kinds of filter media can be used in the range of achieving the effect of the present invention. As the filter medium 200, for example, it is possible to use various kinds of ceramics such as alumina, various kinds of carbon-based materials such as coal, charcoal, coal coke, petroleum coke, pitch coke, activated carbon using these, and particulate activated carbon obtained by granulating carbon black with a thermosetting resin such as pitch/tar binder/phenol, activated alumina, activated clay, silica gel, zeolite, and the like.

In the present embodiment, the filter medium 200 is preferably formed of at least one kind of a carbon-based material or activated carbon and more preferably formed of activated carbon. By this, the filter medium 200 has a lower specific gravity than the filter sand used in the first filter layer 24 of the water to be treated filtering unit 11, and it is thus easy to provide the second filter layer 25 containing the filter medium 200 on the first filter layer 24. In addition, a carbon-based material and activated carbon exhibit high affinity for organic substances, and it is thus possible to efficiently remove the suspended substances due to the organic substances in the water to be treated W₁.

Next, a process for producing the filter medium 200 according to the present embodiment will be described. In the process for producing the filter medium 200 according to the present embodiment, the filter medium 200 in which the cumulative pore volume of pores having a pore radius of 2 nm or less is 25% or less with respect to the cumulative pore volume of pores having a pore radius of 50 nm or less is manufactured by activating the various kinds of carbon-based materials described above with water vapor and/or a carbonic acid gas. According to this process, it is possible to decrease the specific surface area of the carbon-based material by appropriately destroying the micropores 103 having a pore radius of 2 nm or less in the carbon-based material by an activation treatment with at least either of water vapor or a carbonic acid gas. It is thus possible to set the cumulative pore volume of pores having a pore radius of 2 nm or less to be 25% or less with respect to the cumulative pore volume of pores having a pore radius of 50 nm or less. This makes it possible to manufacture the filter medium 200 capable of promptly desorbing the suspended substances from the filter medium at the time of backwashing as well as efficiently adsorbing suspended substances in the water to be treated W₁.

As the condition for the activation treatment in a case in which the activation treatment is conducted with water vapor, a condition is preferable in which the surface temperature of the carbon-based material is 750° C. or higher and 850° C. or lower and the time is 12 hours or longer and 72 hours or shorter, that is longer than that for a general activation treatment of activated carbon. In addition, in a case in which the activation treatment is conducted with a carbonic acid gas, a condition is preferable in which the surface temperature of the carbon-based material is 850° C. or higher and 950° C. or lower and the time is 12 hours or longer and 72 hours or shorter, that is longer than that for a general activation treatment of activated carbon By appropriately destroying the micropores having a pore radius of 2 nm or less in the carbon-based material by activating the carbon-based material under such a condition, it is possible to obtain the filter medium 200 in which the cumulative pore volume of pores having a pore radius of 2 nm or less is 25% or less with respect to the cumulative pore volume of pores having a pore radius of 50 nm or less.

In addition as the condition for the activation treatment, it is preferable to conduct the activation treatment until the mass decrease of the carbon-based material caused by gasification and wear reaches 50% or more under the condition of temperature and time described above. By this, the destruction of the micropores 103 having a pore radius of 2 nm or less in the carbon-based material is conducted in an appropriate range. It is thus possible to easily obtain the filter medium 200 in which the cumulative pore volume of pores having a pore radius of 2 nm or less is 25% or less with respect to the cumulative pore volume of pores having a pore radius of 50 nm or less. In addition, the mass decrease by the activation treatment is more preferably 75% or more and still more preferably 80% or more from the viewpoint of even more easily manufacturing the filter medium 200 in which the cumulative pore volume of pores having a pore radius of 2 nm or less is 25% or less with respect to the cumulative pore volume of pores having a pore radius of 50 nm or less.

As described above, according to the filter medium 200 of the present embodiment, the cumulative pore volume of pores having a pore radius of 2 nm or less is 25% or less with respect to the cumulative pore volume of pores having a pore radius of 50 nm or less. It is thus possible to efficiently desorb the suspended substances retained in the filter medium from the filter medium at the time of backwashing as well as to efficiently remove the suspended substances contained in the water to be treated W₁. Hence, it is possible to realize the filter medium 200 capable of promptly regenerating the adsorption power by backwashing and realizing efficient operation of the filtration device. Moreover, by using this filter medium 200, it is possible to efficiently operate the filtration device by only applying the filter medium 200 without greatly changing the structure of the filtration device main body.

Incidentally, in the embodiment described above, an example in which the filter medium 200 according to the present embodiment is applied to the water to be treated filtering unit 11 has been described, but the present invention is not limited to the water to be treated filtering unit 11 and can be applied to various kinds of filtration devices.

Next, a method of operating a filtration device according to the present embodiment will be described. The method of operating a filtration device according to the present embodiment includes: a filtering step of filtering the water to be treated through the filter medium to decrease the suspended substances in the water to be treated; and a washing step of backwashing the filter medium when the amount of suspended substances in the water to be treated filtered through the filter medium reaches one third or more of the total amount adsorbed to the filter medium. In other words, in the method of operating a filtration device according to the present embodiment, the total amount adsorbed to the filter medium with respect to the concentration of suspended substances in the water to be treated is adjusted so as to be three-fold or more the integrated amount of suspended substances which pass through the filter medium during the operation period between the backwashing intervals of the filtration device. Incidentally, in the method of operating a filtration device according to the present embodiment, it is not necessarily required to use the filter medium 200 according to the embodiment described above as the filter medium, and various kinds of filter media can be used.

According to this method of operating a filtration device, it is possible to conduct backwashing under a condition having a sufficient margin with respect to the adsorption capacity of the filter medium and thus to prevent excessive adsorption of the suspended substances into pores of the filter medium. In addition, the filtration device is operated in a range having a sufficient margin in the adsorption capacity of the filter medium, and it is thus possible to prevent permeation of the suspended substances in the water to be treated through the filtration device even if there are suspended substances which are not desorbed from the inside of the pores of the filter medium by backwashing. Furthermore, there is a margin in the adsorption capacity of filter medium and it is thus possible to prevent permeation of the suspended substances in the water to be treated through the filtration device even in a case in which it is not possible to completely remove the suspended substances from the filter medium by one time of backwashing. This makes it possible to promptly desorb the suspended substances adsorbed to the filter medium from the filter medium at the time of backwashing, and it is thus possible to realize a method of operating a filtration device capable of promptly regenerating the adsorption power by backwashing and realizing efficient operation.

In the method of operating a filtration device according to the present embodiment, the total amount adsorbed to the filter medium with respect to the concentration of suspended substances in the water to be treated is set to be preferably five-fold or more and still more preferably 10-fold or more the integrated amount of suspended substances which pass through the filter medium during the operation period between the backwashing intervals of the filtration device from the viewpoint of even further improving the effect described above.

In addition, in the method of operating a dual media filtration device according to the present embodiment, for example, the kind and used amount of filter medium are determined so that the following relational expression is satisfied.

Amount adsorbed to filter medium per unit mass in concentration of suspended substances in water to be treated (mg/kg)×used amount (kg) of filter medium={concentration of suspended substances in water to be treated (mg/kg)−concentration of suspended substances in filtered water (mg/kg)}×operation time of filtration device between backwashing treatments (h)×flow rate of water to be treated permeating through filter medium (m³/h)×1000×3 (or 5 or 10)

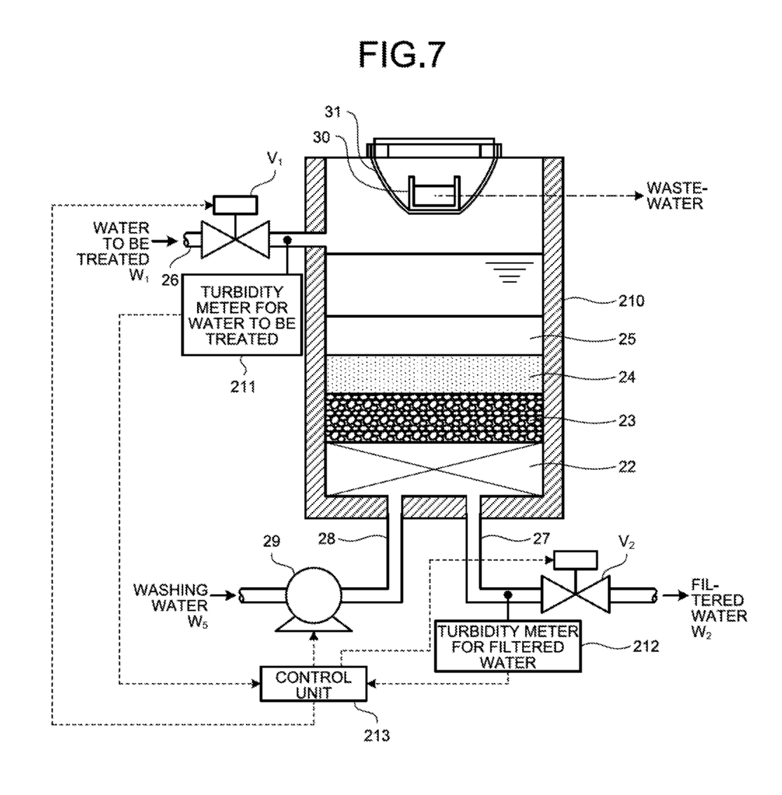

FIG. 7 is a diagram illustrating another example of the filtration device according to the present embodiment. As illustrated in FIG. 7, this filtration device 210 is equipped with: a turbidity meter for water to be treated (device for measuring concentration of suspended substances in water to be treated) 211 that is provided to the water to be treated supply pipe 26; a turbidity meter for filtered water (device for measuring concentration of suspended substances in filtered water) 212 that is provided to the filtered water effluence pipe 27; and a control unit 213 which calculates the amount of suspended substances in the water to be treated W₁ measured by the turbidity meter for water to be treated 211 and the amount of suspended substances in the filtered water W₂ measured by the turbidity meter for filtered water 212 and controls the operation of the filtration device 210 based on the result of calculation in addition to the configuration of the filtration tank 21 illustrated in FIG. 2.

The turbidity meter for water to be treated 211 is provided on the upstream side to the filter medium 200 in the flow path of the water to be treated W₁. The turbidity meter for water to be treated 211 measures the concentration of suspended substances in the water to be treated W₁ before being filtered through the filter medium 200. The turbidity meter for filtered water 212 is provided on the downstream side to the filter medium 200 in the flow path of the water to be treated W₁. The turbidity meter for filtered water 212 measures the concentration of the filtered water W₂ that is the water to be treated W₁ after being filtered through the filter medium. The turbidity meter for water to be treated 211 and the turbidity meter for filtered water 212 are not particularly limited as long as they can measure the concentration of the water to be treated W₁ or the filtered water W₂.

The control unit 213 is realized, for example, by utilizing a general purpose or dedicated computer such as a CPU (Central Processing Unit), a ROM (Read Only Memory), or a RAM (Random Access Memory) and a program operating on the computer. The control unit 213 calculates the time integrated value (cumulative value per predetermined time) of the concentration of suspended substances in the water to be treated W₁ measured by the turbidity meter for water to be treated 211. In addition, the control unit 213 calculates the time integrated value (cumulative value per predetermined time) per predetermined time of the concentration of suspended substances in the filtered water W₂ measured by the turbidity meter for filtered water 212. The control unit 213 calculates a difference value between the time integrated value per predetermined time of the concentration of suspended substances in the water to be treated W₁ calculated and the time integrated value per predetermined time of the concentration of suspended substances in the filtered water W₂ calculated. The control unit 213 determines whether or not the difference value calculated is equal to or less than a predetermined threshold value. Furthermore, the control unit 213 continues the normal operation of the filtration device 210 in a case in which the difference value calculated is equal to or less than the predetermined threshold value. In addition, in a case in which the difference value calculated exceeds the predetermined threshold value, the control unit 213 closes the flow regulating valve V₁ of the water to be treated supply pipe 26 and the flow regulating valve V₂ of the filtered water effluence pipe 27 and then supplies the washing water W₅ into the filtration device 210 through the washing water supply pipe 28 by driving the liquid sending pump 29 to conduct backwashing of the filter medium 200. In addition, after backwashing of the filtration device 210, the control unit 213 erases the time integrated value per predetermined time of the concentration of suspended substances in the water to be treated W₁ calculated and the time integrated value per predetermined time of the concentration of suspended substances in the filtered water W₂ calculated. Thereafter, the control unit 213 calculates the time integrated value per predetermined time (integrated value) of the concentration of suspended substances in the water to be treated W₁ measured by the turbidity meter for water to be treated 211 and the time integrated value per predetermined time (integrated value) of the concentration of suspended substances in the filtered water W₂ measured by the turbidity meter for filtered water 212 again.

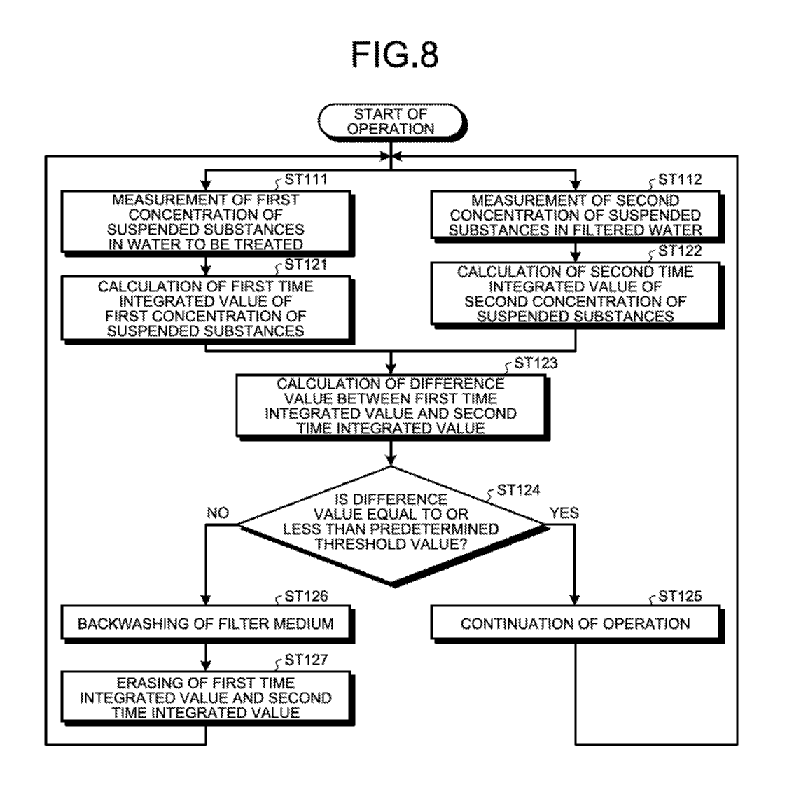

Next, the method for operating the filtration device 210 will be described in detail with reference to FIG. 8. FIG. 8 is a flow diagram of the method for operating the filtration device 210 according to the present embodiment. As illustrated in FIG. 8, the method for operating the filtration device 210 according to the present embodiment includes: a concentration of suspended substances measuring step of respectively measuring the first concentration of suspended substances in the water to be treated W₁ and the second concentration of suspended substances in the filtered water W₂ obtained as the water to be treated W₁ is filtered through the filter medium; and a filter medium washing step of conducting backwashing of the filter medium based on the difference value between the first time integrated value (cumulative value) of the first concentration of suspended substances in the water to be treated W₁ measured and the second time integrated value (cumulative value) of the second concentration of suspended substances in the filtered water W₂ measured.

In the concentration of suspended substances measuring step, the turbidity meter for water to be treated 211 measures the first concentration of suspended substances in the water to be treated W₁ (step ST111). In addition, in the concentration of suspended substances measuring step, the turbidity meter for filtered water 212 measures the second concentration of suspended substances in the filtered water W₂ (step ST112).

After the start of operation of the filtration device 210, in the amount of suspended substances evaluating step, the control unit 213 calculates the first time integrated value per predetermined time of the first concentration of suspended substances in the water to be treated W₁ measured by the turbidity meter for water to be treated 211 (step ST121). Next, the control unit 213 calculates the second time integrated value per predetermined time of the second concentration of suspended substances in the filtered water W₂ measured by the turbidity meter for filtered water 212 (step ST122). Subsequently, the control unit 213 calculates the difference value between the first time integrated value per predetermined time of the first concentration of suspended substances in the water to be treated W₁ calculated and the second time integrated value per predetermined time of the second concentration of suspended substances in the filtered water W₂ calculated (step ST123) and determines whether or not the difference value calculated is equal to or less than a predetermined threshold value (step ST124). Thereafter, the control unit 213 continues the normal operation of the filtration device 210 (step ST125) in a case in which the difference value calculated is equal to or less than the predetermined threshold value (step ST124: Yes). In addition, in a case in which the difference value calculated exceeds the predetermined threshold value (step ST124: No), the control unit 213 closes the flow regulating valve V₁ of the water to be treated supply pipe 26 and the flow regulating valve V₂ of the filtered water effluence pipe 27 and then supplies the washing water W₅ into the filtration device 210 through the washing water supply pipe 28 by driving the liquid sending pump 29 to conduct backwashing of the filter medium 200 (step ST126). Next, after backwashing of the filtration device 210, the control unit 213 erases the first time integrated value per predetermined time of the first concentration of suspended substances in the water to be treated W₁ calculated and the second time integrated value per predetermined time of the second concentration of suspended substances in the filtered water W₂ calculated (step ST127). Thereafter, the control unit 213 calculates the first time integrated value per predetermined time of the first concentration of suspended substances in the water to be treated W₁ measured by the turbidity meter for water to be treated 211 and the second time integrated value per predetermined time of the second concentration of suspended substances in the filtered water W₂ measured by the turbidity meter for filtered water 212 again (steps ST111, ST112, ST121, and ST122).

In addition, in the method of operating a filtration device according to the present embodiment, the kind and used amount of the filter medium are determined so that the first concentration of suspended substances to be measured by the turbidity meter for water to be treated 211 provided on the upstream side of the filter medium and the second concentration of suspended substances to be measured by the turbidity meter for filtered water 212 provided on the downstream side of the filter medium satisfy the following relational expression.

Amount adsorbed to filter medium per unit mass in first concentration of suspended substances in water to be treated W₁ (mg/kg)×used amount (kg) of filter medium={first time integrated value of first concentration of suspended substances in water to be treated W₁ (mg/kg·h)−second time integrated value of second concentration of suspended substances in filtered water W₂ (mg/kg·h)}×flow rate of water to be treated W₁ permeating through filter medium (m³/h)

As described above, according to the method for operating the filtration device 210 according to the present embodiment, it is possible to accurately ascertain the amount of suspended substances adsorbed to the filter medium based on the difference value between the first time integrated value of the first concentration of suspended substances to be measured by the turbidity meter for water to be treated 211 provided on the upstream side of the filter medium and the second time integrated value of the second concentration of suspended substances to be measured by the turbidity meter for filtered water 212 provided on the downstream side of the filter medium. It is thus to sufficiently set the operation time of the filtration device 210 required until the backwashing. This makes it possible for the method for operating the filtration device 210 to prevent the deterioration in performance of the filtration device 210 due to poor washing of the suspended substances adsorbed to the filter medium at the time of backwashing caused in a case in which the operation time of the filtration device 210 is too long. In addition, the method for operating the filtration device 210 can also prevent a decrease in the rate of operation of the filtration device 210 due to an increase in the number of backwashing caused in a case in which the operation time of the filtration device 210 is too short.

Incidentally, in the embodiment described above, the turbidity meter for water to be treated 211 and the turbidity meter for filtered water 212 are used, but it is also possible to use a concentration meter for organic substances such as a TOG (total organic carbon) meter instead of a turbidity meter. It is possible to operate the filtration device 210 in the same manner as the above by taking the concentration of suspended substances as the concentration of organic substances in the case of using a concentration meter for organic substances.

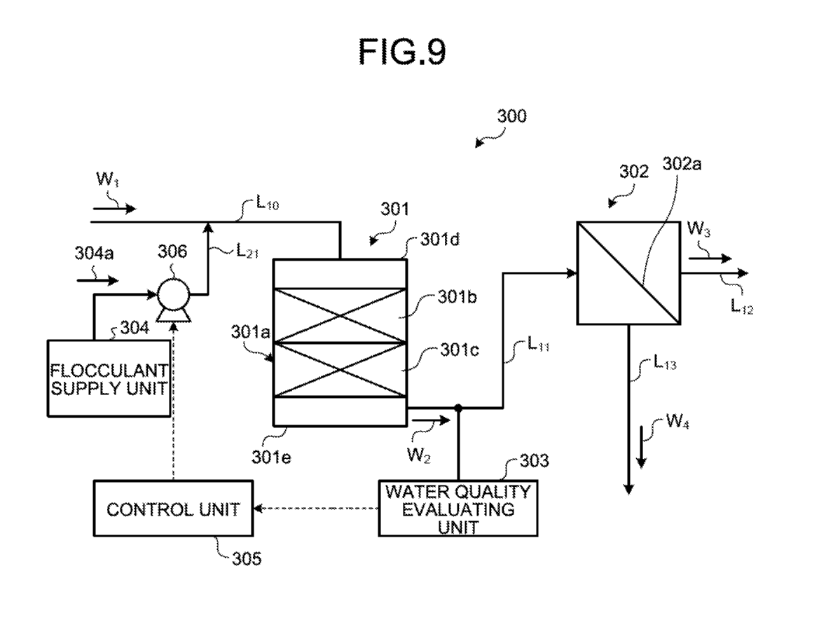

Next, the filtration system according to the present embodiment will be described with reference to FIG. 9. FIG. 9 is a schematic diagram of a filtration system 300 according to the present embodiment. As illustrated in FIG. 9, the filtration system 300 according to the present embodiment is equipped with: a filtration device 301 to which a water to be treated line L₁₀ is connected; and a salt enriching unit 302 provided at the subsequent stage of the filtration device 301. A filtered water line L₁₁ is provided between the filtration device 301 and the salt enriching unit 302.

The water to be treated line L₁₀ supplies the water to be treated W₁ of raw water such as seawater to the filtration device 301. The filtration device 301 filters the water to be treated W₁ supplied through the water to be treated line L₁₀ to obtain the filtered water W₂. In addition, the filtration device 301 supplies the filtered water W₂ to the salt enriching unit 302 via the filtered water line L₁₁. The salt enriching unit 302 permeates the filtered water through a separation membrane 302a to obtain the permeated water W₃ in which the salts in the filtered water W₂ are removed and the enriched water W₄ in which the salts in the filtered water W₂ are enriched. In addition, the salt enriching unit 302 discharges the enriched water W₄ via the enriched water discharge line L₁₃ as well as supplies the permeated water W₃ to the various kinds of devices (not illustrated) at the subsequent stages via the permeated water line L₁₂. The separation membrane 302a is not particularly limited as long as the permeated water W₃ and the enriched water W₄ can be obtained from the filtered water W₂.

The filtration device 301 is equipped with a first filter layer 301b and a second filter layer 301c layered in a filtration device main body 301a. The first filter layer 301b is provided on a top portion 301d side of the filtration device main body 301a and is configured to include the filter medium 200 described above. The second filter layer 301c is provided on a bottom portion 301e side of the filtration device main body 301a and is configured to include a particulate filter medium such as silica sand. The inorganic impurities in the water to be treated W₁ are removed by these first filter layer 301b and second filter layer 301c, and it is thus possible to measure and ascertain the concentration of suspended substances in the water to be treated W₁ based on the organic substance-based impurities by a water quality evaluating unit 303 to be described later.

In addition, the filtration system 300 according to the present embodiment is equipped with: the water quality evaluating unit 303 which evaluates the quality of the filtered water W₂ flowing through the filtered water line L₁₁; a flocculant supply unit 304 which supplies a flocculant 304a to the water to be treated line L₁₀ via a flocculant supply line L₂₁; and a control unit 305 which controls the amount of flocculant to be supplied from the flocculant supply unit 304 based on the evaluation result of water quality of the filtered water W₂ by the water quality evaluating unit 303.

The water quality evaluating unit 303 measures and monitors the concentration of suspended substances such as organic substances in the water to be treated W₁. The control unit 305 determines whether or not the concentration of suspended substances in the water to be treated W₁ measured by the water quality evaluating unit 303 is equal to or higher than a predetermined threshold value. Thereafter, the control unit 305 supplies the flocculant 304a from the flocculant supply unit 304 to the water to be treated line L₁₀ by operating a chemical supply pump 306 provided to the flocculant supply line L₂₁ in a case in which the concentration of suspended substances in the water to be treated W₁ is equal to or higher than the predetermined threshold value. In addition, the control unit 305 stops supply of the flocculant 304a from the flocculant supply unit 304 to the water to be treated line L₁₀ by stopping the chemical supply pump 306 in a case in which the concentration of suspended substances in the water to be treated W₁ is less than the predetermined threshold value.

As described above, according to the filtration system 300 of the present embodiment, the filtration device 301 in which the micropores having a pore radius of 0.8 nm or more and 2 nm or less and the submicropores having a pore radius of 0.8 nm or less, which make it difficult to desorb the adsorbed suspended substances from the filter medium 200 at the time of backwashing are decreased is equipped and it is thus possible to promptly desorb the suspended substances from the filter medium 200 at the time of backwashing. This makes it possible to more promptly regenerate the adsorption power of the filter medium of the filtration device 310 by backwashing and to realize more efficient operation of the filtration system.

### REFERENCE SIGNS LIST

1 Water Treatment Apparatus

11 Dual Media Filtration Device

12 Reverse Osmosis Membrane Filtering Unit

12a Reverse Osmosis Membrane

13 Energy Recovery Unit

14 Pump

15 High Pressure Pump

21, 210, and 301 Filtration Device

22 Perforated Block

23 Ground Layer

24 First Filter Layer

25 Second Filter Layer

26 Water to be Treated Supply Pipe

27 Filtered Water Effluence Pipe

28 Washing Water Supply Pipe

29 Liquid Sending Pump

30 Drainage Gutter

31 Filter Medium Effluence Preventing Net

100 and 200 Filter Medium

101 Macropore

102 Mesopore

103 Micropore

211 Turbidity Meter for Water to be Treated (Device for Measuring Concentration of Suspended Substances in Water to be Treated)

212 Turbidity Meter for Filtered Water (Device for Measuring Concentration of Suspended Substances in Filtered Water)

213, 305 Control Unit

300 Filtration System

301a Filtration Device Main Body

301b First Filter Layer

301c Second Filter Layer

301d Top Portion

301e Bottom Portion

302 Salt Enriching Unit

302a Separation Membrane

303 Water Quality Evaluating Unit

304 Flocculant Supply Unit

304a Flocculant

306 Chemical Supply Pump

L₁ and L₁₀ Water to be Treated Line

L₂ and L₁₁ Filtered Water Line

L₃ Enriched Water Line

L₄ Permeated Water Line

L₁₂ Permeated Water Line

L₁₃ Enriched Water Discharge Line

L₂₁ Flocculant Supply Line

V₁ and V₂ Flow Regulating Valve

W₁ Water to be Treated

W₂ Filtered Water

W₃ Permeated Water

W₄ Enriched Water

W₅ Washing Water

1. A filter medium, wherein a cumulative pore volume of pores having a pore radius of 2 nm or less is 25% or less with respect to a cumulative pore volume of pores having a pore radius of 50 nm or less.

2. The filter medium according to claim 1, comprising a carbon-based material.

3. The filter medium according to claim 2, wherein the carbon-based material contains activated carbon.

4. A process for producing the filter medium according to claim 1, wherein a carbon-based material is activated by water vapor.

5. A process for producing the filter medium according to claim 1, wherein a carbon-based material is activated by a carbonic acid gas.

6. The process for producing the filter medium according to claim 4, wherein the activation treatment is conducted with water vapor under a condition having a surface temperature of the carbon-based material of 750° C. or higher.

7. The process for producing the filter medium according to claim 5, wherein the activation treatment is conducted with the carbonic acid gas under a condition having a surface temperature of the carbon-based material of 850° C. or higher.

8. The process for producing the filter medium according to claim 4, wherein the activation treatment is conducted until a mass decrease of the carbon-based material reaches 50% or more.

9. A filtration device comprising the filter medium claim 1.

10. A method for operating the filtration device according to claim 9, the method comprising:
a filtering step of filtering water to be treated through the filter medium to decrease suspended substances in the water to be treated; and
a washing step of washing the filter medium by backwashing when an amount of suspended substances in water to be treated filtered through the filter medium reaches one third of a total amount adsorbed to the filter medium.

11. A method for operating the filtration device according to claim 9, the method comprising:
a concentration of suspended substances measuring step of measuring a first concentration of suspended substances in the water to be treated and measuring a second concentration of suspended substances in filtered water, the filtered water is obtained by filtering the water to be treated through the filter medium; and
a filter medium washing step of conducting a calculation of a difference value between a first time integrated value of the first concentration of suspended substances measured and a second time integrated value of the second concentration of suspended substances measured and conducting a backwashing of the filter medium when the difference value calculated is equal to or less than a predetermined value.

12. A filtration system comprising:
a water to be treated filtering unit equipped with the filtration device according to claim 9 that filters water to be treated supplied through a water to be treated line to obtain filtered water; and
a salt enriching unit that filters the filtered water through a separation membrane to obtain permeated water and enriched water.
